(19) United States
(12) Patent Application Publication
(10) Pub. No.: US 2009/0019751 A1
(43) Pub. Date: Jan. 22, 2009

(54) Removably attachable card and card retaining device

(76) Inventor: Thomas J. Goetting, Lubec, ME (US)

Correspondence Address: SANFORD J. PILTCH, ESQ., 1132 HAMILTON STREET, SUITE 201, ALLENTOWN, PA, 18101, US

(21) Appl. No.: 11/880,177

(22) Filed: Jul. 20, 2007

(51) Int. Cl. G09F 3/08

(52) U.S. Cl. 40/663; 40/661.11; 40/664; 40/673

(57) ABSTRACT

An improved combination card and card retaining member for removably securing the card to the card retaining member, the card having formed within it an aperture and a slot connecting the aperture with an edge of the card, and the card retaining member being a member, such as a ring, which may be passed through the slot and into the aperture to secure the card to the card retaining member. The aperture and slot are configured and located on the card in such a manner as to improve the ease of attachment and detachment of the card to and from the card retaining member while minimizing the risk of accidental detachment of the card from the card retaining member. One or more cards may be used simultaneously with a single card retaining member. A preferred use of the invention is to retain and organize credit cards.

### BACKGROUND OF THE INVENTION

The present invention relates generally to the field of information-bearing cards, and particularly to means and methods for securely attaching information-bearing cards to card-retaining members. The improved information-bearing cards and card retaining members provide for any card to be easily secured to the card retaining member and easily detached therefrom as well, while reducing the incidence of accidental detachment of the card from the card retaining member.

Information-bearing cards are commonly found today. Examples of information bearing cards include credit cards bearing information such as cardholder name, account number, and bank name; and hotel room access cards bearing information such as a room or door lock pass code. This information is incorporated into the card as embossed alphanumeric characters, as information recorded on a magnetic strip, as a hologram, and/or as printed information. An information-bearing card can also include a bar code, a dot-matrix code, a UPC code, Braille, or other image code.

Credit cards are typically made from plastics, and consequently can be bent, twisted, and flexed by a user. Moderate bending, twisting, or flexing will not damage the card, and the card will return to an original flat configuration.

There are other types of information-bearing cards, and such cards are often made of plastic, although other materials can also be used, such as paper, laminated paper, and laminated paper and plastic combinations. Other examples of information-bearing cards include: library cards, discount cards, gift cards, bank cards, ATM cards, membership cards, account cards, and photo identification cards. Cards bearing decorative graphics are also considered to be “information-bearing” cards. Cards that include an RFID chip, or other information-bearing chip, are also considered to be “information-bearing” cards.

Most people carry their information bearing cards, such as their credit cards, in a wallet or purse. Sometimes a “card holder” is used. However, cards fall out of wallets, and sometimes people forget to return the card to their wallet or purse. Thus, loss of such cards is a common event, and the inconvenience due to the loss of a credit card can be considerable. Upon loss of a credit card, one must report the card “lost or stolen”. Loss of the card may mean that access to funds is no longer possible until the card is recovered or replaced, this possibly taking days or even weeks.

Due to the widespread use and importance of such information-bearing cards, means and methods for retaining such cards are known. For example, it is known to simply include a round hole near one end of the card, such that a key ring may be passed through the hole. However, it is usually quite difficult for an individual to attach a card to a key ring or easily remove it to pass through a card reader.

A number of earlier patents disclose various configurations of cards and card retaining devices. Many such devices simply include an aperture formed into the card, through which a key ring, a chain, a lanyard, or some other retention device must be threaded through the hole. For example, U.S. Pat. No. 6,076,296 [Schaeffer] discloses a cardholder for a mass transit entry card. The cardholder securement means is a releasable attachment, integral to the card, for temporary attachment to the user's clothing, providing an extension to a manual-grasping portion of the card used for passing the card through a reader so that the card can be read while still held by the reader. The securement means of the Schaeffer patent is limited to use with only one a single card, thereby, leaving a need for a retaining member that can be used with and hold a plurality of information-bearing cards.

U.S. Patent Application Publication US 2003/0222153 A1 (Dec. 4, 2003) [Pentz, et al.] discloses a data or credit card that is reduced in size from the conventional standard credit card size with a hole located in one corner of the card for attaching to a key chain. The Pentz application, is directed more to the contents of the data on the card, and how that data is housed and configured. However, the description of a hole for attaching the data card to a key chain still requires the opening and re-closing of the key chain, a cumbersome task to be associated with the reduced size card. Additionally, the Pentz disclosure does not contemplate an aperture associated with a channel that would easily permit the passage of a card-retaining member, e.g., a key chain or retaining ring, from the edge of the card to the aperture without the need to open, or thread the retaining device through the hole, and then re-close the device for secure attachment.

U.S. Patent Application Publication US 2003/0014891 A1 (Jan. 23, 2003) [Nelms, et al.] discloses a non-rectangular shaped credit card with an associated case or holder. The credit card may have an aperture to permit passage of a key chain loop to allow attachment of keys to the case to permit the key chain aspect of the case to be accomplished, but the primary focus is to provide a curvilinear notch in the card to permit the rotation of the card around a pivot pin in the case to provide for easy access, insertion and removal, of the card from the case. A hole can be placed through the pivot pin for attachment of the case to a key chain ring or the like. Therefore, there remains a need for a retaining means that would fit a standard sized card without the need of a case, and that would allow for a card-retaining member to pass easily into the aperture to hold a plurality of information cards.

U.S. Pat. No. 4,521,981 [Kasprzycki] describes a key holder tag with a removably insertable marketing or advertising insert sheet or card. The key holder of Kasprzycki is formed as an elongated slot in a corner of the key holder and does not contemplate use with a data or credit card; the device is limited to use with hotel keys. Kasprzycki does not disclose any means for accessing the hole or slot in the corner of the key holder, but merely associates an articulating key chain as the preferred means for attaching a key to the holder.

It is known to attempt to maintain control over multiple cards by holding them using one of a number “card holders” having varied configurations that are widely available. These devices, such as wallets, money clips, and card clips, for example, employ leather, plastic, or metal to surround, grasp, and/or otherwise contain one or more cards. Other configurations allow for easy detachment and reattachment of the card from the card retaining device.

In the Schaeffer patent cited above, a card with an integrated hook member for attaching said card to a strap or pocket is described. Further, the hook member is substantially coplanar with the main body of the card. While this configuration achieves the above-stated goal, it requires a specially designed card and thus is not adaptable to standard credit cards. Similarly, U.S. Pat. No. 4,462,175 [Romberger] describes a safety tag holder designed specifically for attaching a warning card to hazardous equipment. The safety hook is comprised of a deflectable holding clip having a length sufficient to create a space between the end of the clip and the hook finger to retain and surround the portion of the hazardous equipment within the aperture formed thereby. However, like the Schaeffer device, the safety hook of Romberger requires not only a specially designed and sized card, but also does not attach by means of any mechanism associated with the card.

The key retainers of both U.S. Pat. No. 4,492,048 [Brewer] and U.S. Pat. No. 4,422,315 [Klose] describe key holders having displaceable hook for retaining keys that are locked in place when inserted into a cooperating sleeve. The hooks may be pulled outward to detach their distal ends from the main body of the key retaining member, to allow for keys to be placed thereon by displacing the hook away from its rest position, and then replaced in a locked coplanar position with the sleeve to retain said keys. Neither of these configurations, however, directly relates to a card, but are rather key holders designed for a plurality of keys to be retained on a single holder.

U.S. Pat. No. 3,583,317 [Gibson] discloses a two-piece credit identification card device with a mechanism for easy detachment from and reattachment to a card retaining device. However, the mechanism involves removing a significant portion of the card itself from the main body of the card by means of a sliding engagement within longitudinal slots on opposite sides of the rectangular opening in the main portion of the card-like device. Similarly, U.S. Pat. No. 5,538,291 [Gustafson] discloses a credit card with a means for easy detachment from and reattachment to a card retaining device. Like Gibson, a portion of the credit card, die cut into the shape of a key, must be removed therefrom. An interlocking portion which couples a key ring to the card removable key portion is also disclosed, which can alternately be used to remove the card from a card retaining device. However, both Gibson and Gustafson require multipart devices and substantial modification to standard credit cards in order to achieve the desired function.

U.S. Pat. No. 5,700,037 [Keller] discloses a multi-layer card having an aperture with a slit formed near an edge for the purpose of providing a grasping point for a user, or to attach the card to a shirt button. This configuration allows for a single card to be easily attached to and detached from a shirt button, but is not amenable to retaining multiple cards on a single retention device. Moreover, the slit is cut such that, when the card is attached to a shirt button, a downward force on the card will easily cause detachment, leading to a risk of inadvertent detachment.

None of the disclosed inventions meet the requirements of providing an easy means for attaching and detaching a standard credit card to and from a card retaining member, while minimizing the risk of inadvertent detachment. The basic configuration of the present invention does allow for the information-bearing card to be easily detached from and reattached to the retention member.

It is therefore an objective of the invention to provide an improved combination of an information-bearing card and card retaining member which permits quick and easy attachment and detachment of the information-bearing card to the card retaining member. It is a further objective of the invention to provide an improved combination of an information-bearing card and card retaining member which minimizes the accidental detachment of the card from the card retaining device.

It is yet a further objective of the invention to provide an improved combination of an information-bearing card and a card retaining member in which the configuration for the card resists breakage during ordinary intended use. It is still a further objective of the invention to provide an improved combination of an information-bearing card and a card retaining member having a configuration for the card which is easy and cost-effective to manufacture.

It is also an objective of the invention to provide an improved combination of an information-bearing card and a card retaining member having a convenient means for organizing and retaining multiple credit cards. The foregoing and other objectives, features, and advantages of the present invention are described in or will become apparent from the following detailed description of the invention and with reference to the drawings.

### SUMMARY OF THE INVENTION

The present invention is an improved information-bearing card and card retaining member for removably securing the card to the card retaining member. The invention is applicable to cards constructed of a substantially rigid yet deformable material such that the shape of the card may be altered by the application of a mechanical force, and upon the cessation of that force the card returns to its original shape.

The invention requires the card to be configured with an aperture and a slot, with the aperture being located within the body of the card and the slot running from the aperture to an edge of the card. The card retaining member may be a closed continuous loop of any suitable shape, such as substantially circular, ovoid, polygonal, or irregular shape, or the card retaining member may be a non-closed member having a substantially linear shape, such as an electric cord, a cable, a wire, a pipe, a rod, etc., onto which the card may be placed by deforming the shape of the card to open the slot and pass a portion of the card retaining member through the slot and into the aperture. The card may be detached from the card retaining member by deforming the shape of the card to open the slot and pass the card retaining member out of the aperture and through the slot. This operation of attaching and detaching the card from the card retaining member may be repeated as often as desired. The configuration and placement of the aperture and the slot on the card provide secure attachment of the card and ease of use. That is, they cooperatively permit easy attachment and detachment of the card from the card retaining member while limiting the risk of accidental detachment of the card when it is attached to the card retaining member. The invention contemplates the use of one or more cards with a single card retaining member.

In a preferred embodiment of the invention the card is substantially rectangular, the aperture is circular, the slot is significantly narrower than the width of the aperture and the card retaining member, the slot is aligned along a tangent to the aperture or at a point the card retaining member is least likely to pull against the aperture and with the slot continuing in a substantially curved manner away from the aperture to one of the edges of the card. The path of the slot forms a retaining “hook” with the greatest amount of card material to resist the card retaining member pulling through the card in the directions the retaining member is most likely to pull. The more circuitous the path of the slot, the more the card material must be deformed to intentionally release the card from the card retaining member. The preferred embodiment of the card retaining member is a substantially circular ring made of a rigid material, such as metal. Use of, the invention in this preferred embodiment requires a simultaneous application of force to the card while moving the card retaining member in a constantly changing direction relative to the card aperture to cause the card retaining member to be removed from the card aperture, thereby minimizing the risk of the card detaching from the card retaining member due to an unintended or accidental application of force. The preferred embodiment also locates the aperture a sufficient distance from any edge of the card to ensure a sufficient amount of card material between any point along the aperture and any card edge to minimize the potential for breakage of the card during ordinary and intended use.

The invention as described above, and as further described in more detail below, may be used to secure many different types of cards to many different kinds of card retaining members. It is anticipated that a primary type of card that will be configured as described is a credit card. Credit cards are typically made of polymer material having the appropriate characteristics of structural strength, resiliency, and memory to sustain the deformability and durability of the invention. Multiple credit cards are typically carried together, so the card retaining member presents an excellent means for retaining, organizing, and using multiple credit cards. The aperture of the card can be positioned within the card body to avoid interfering with the magnetic strip typically found along one edge of credit cards, as well as to avoid interfering with the embossing typically found on the face of a card. Credit cards attached to the card retaining member may be used while still attached, for example, the credit card may be “swiped” through a card reader to access information stored on the magnetic strip, or if preferred, the credit card may be easily detached for use, then quickly reattached upon completion of the use. Other types of information-based cards similarly configured to credit cards, for example, bank debit cards, identification cards, drivers' licenses, insurance cards, and the like, are also anticipated as being especially well-suited to use with this invention. The foregoing list is not intended to be exhaustive, however, and the invention is deemed applicable to any type of card having the appropriate characteristics of deformability and durability.

In addition to the ease of use of the invention, the design of the invention lends itself to ease of manufacture and thus ready acceptance by the credit card industry. An aperture and slot may be quickly and easily formed into a card by means of a punch tool. A properly configured punch tool may be used to rapidly punch out the aperture and slot in a single action on an automated basis. The details of achieving this result are well-known in the art. An alternative means for forming the aperture into a polymer card includes melting the aperture. This alternative results in a built-up polymer ridge along the circumference of the aperture that adds structural strength to resist an unintentional force pulling the card from the card retaining device. Other means for forming the aperture and slot into the card are also available, and this invention does not restrict the manner of manufacture.

An alternative use for the invention includes its use for lock-out/tag-out cards. These cards are typically made of a heavy grade paper or a plastic material, and are used with industrial equipment to alert users to an atypical operational status of that equipment. For example, when a piece of equipment is to be cleaned, it typically should not also be operating, for both the safety of the person performing the cleaning and also to ensure proper access to its components. The operational control of that piece of equipment should therefore have some sort of indicator to alert potential operators that cleaning is occurring, and that the equipment should not be operating. The lock-out component is typically a mechanical device of some sort to physically prevent activation of the operational controller, and the tag-out component is typically a card with some sort of warning label. Tag-out cards found in the prior art typically are attached to the appropriate component by string, twine, wire, and the like, making it inconvenient to attach and detach and potentially providing a disincentive to the use of such tags. Applying the present invention to tag-out cards will improve the ease of use of the tags, while ensuring the security of the attachment of the tags.

Another alternative use of the invention is its application to temporary magnetic strip keys or entry cards. Cutting the aperture and slot into an entry card enables conveniently retaining it on a user's key chain or neck lanyard.

Another alternative use for the invention is for the organization of business cards. Business cards are typically constructed of a heavy grade paper that will accommodate an aperture and slot being cut into them. The card retaining member serves to keep business cards together, yet allows easy removal of a card for reference or for distribution.

Other features and advantages of the invention are described below.

### DETAILED DESCRIPTION OF THE DRAWINGS

For the purpose of illustrating the invention, there is shown in the drawings forms which are presently preferred; it being understood, however, that the invention is not limited to the precise arrangements and instrumentalities shown.

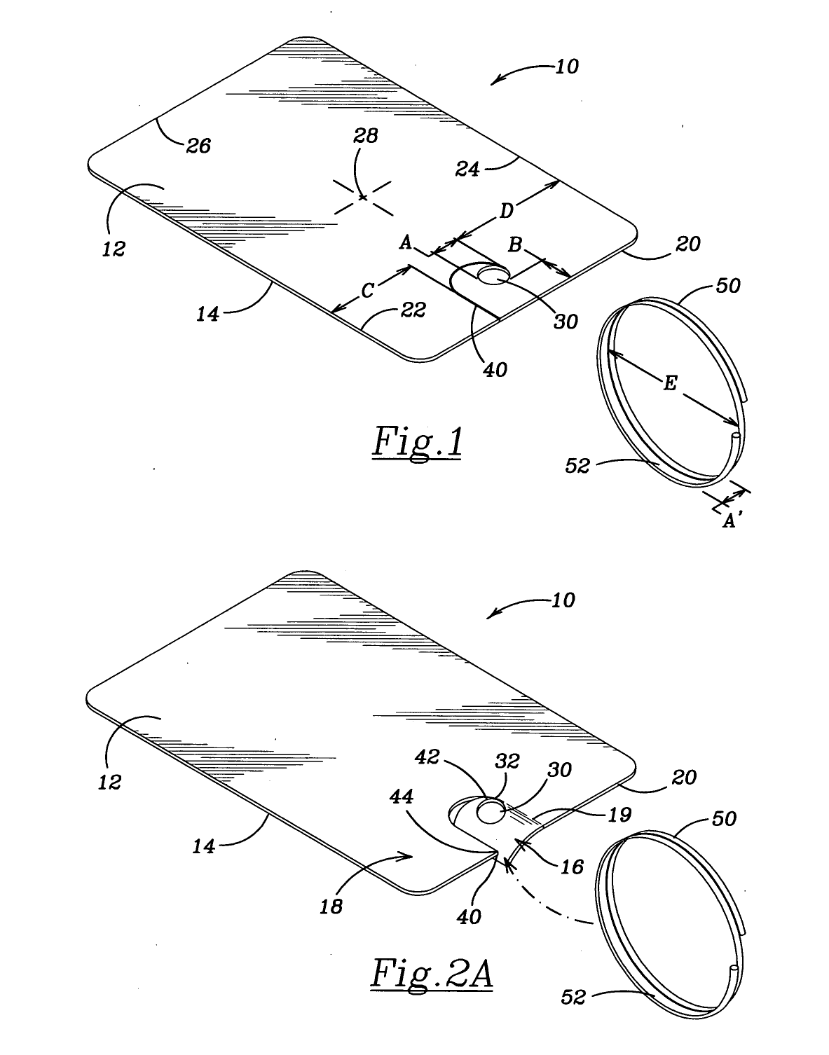

FIG. 1 is a first perspective view of a first embodiment of the present invention showing one set of dimensional criteria for a one-ply card with a card retaining member.

FIG. 2A is a second perspective view of the first embodiment of the present invention showing the manner in which the card may be deformed to permit the insertion into and attachment of the card to the card retaining member.

FIG. 2B is a third perspective view of the first embodiment of the present invention showing the card retaining member attached to the card.

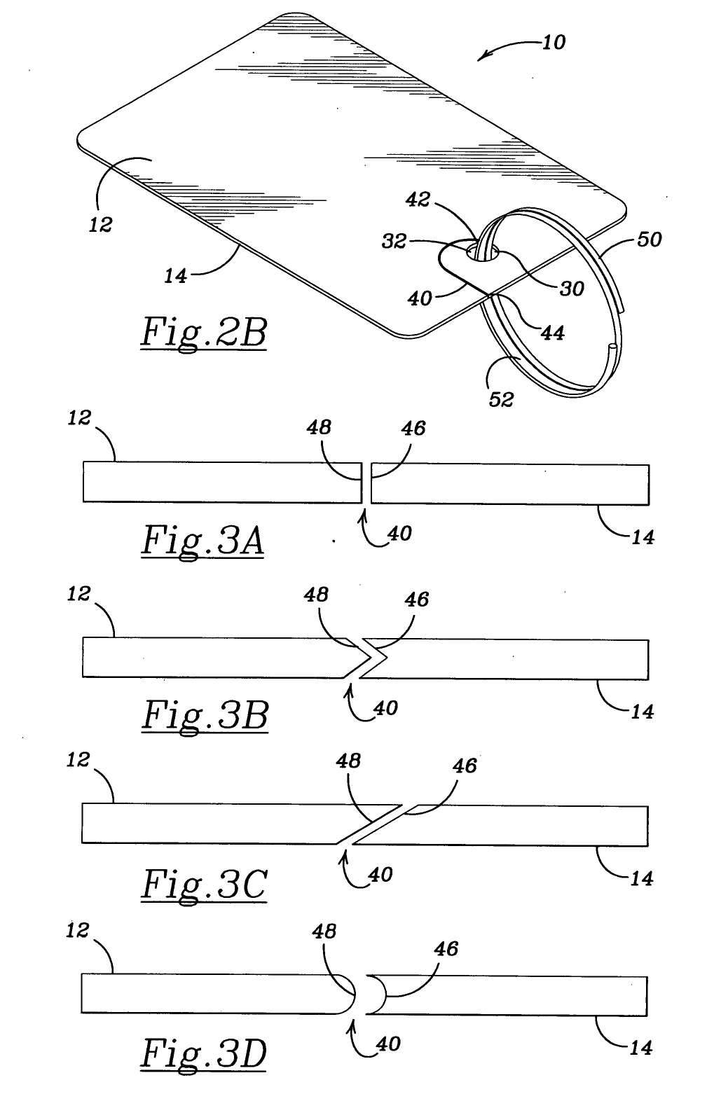

FIG. 3A is a side elevational view of the single-ply card of the first embodiment of the present invention depicting a first geometry for the slot of the card retaining member capture means.

FIG. 3B is a side elevational view of the single-ply card of the first embodiment of the present invention depicting a second geometry for the slot of the card retaining member capture means.

FIG. 3C is a side elevational view of the single-ply card of the first embodiment of the present invention depicting a third geometry for the slot of the card retaining member capture means.

FIG. 3D is a side elevational view of the single-ply card of the first embodiment of the present invention depicting a fourth geometry for the slot of the card retaining member capture means.

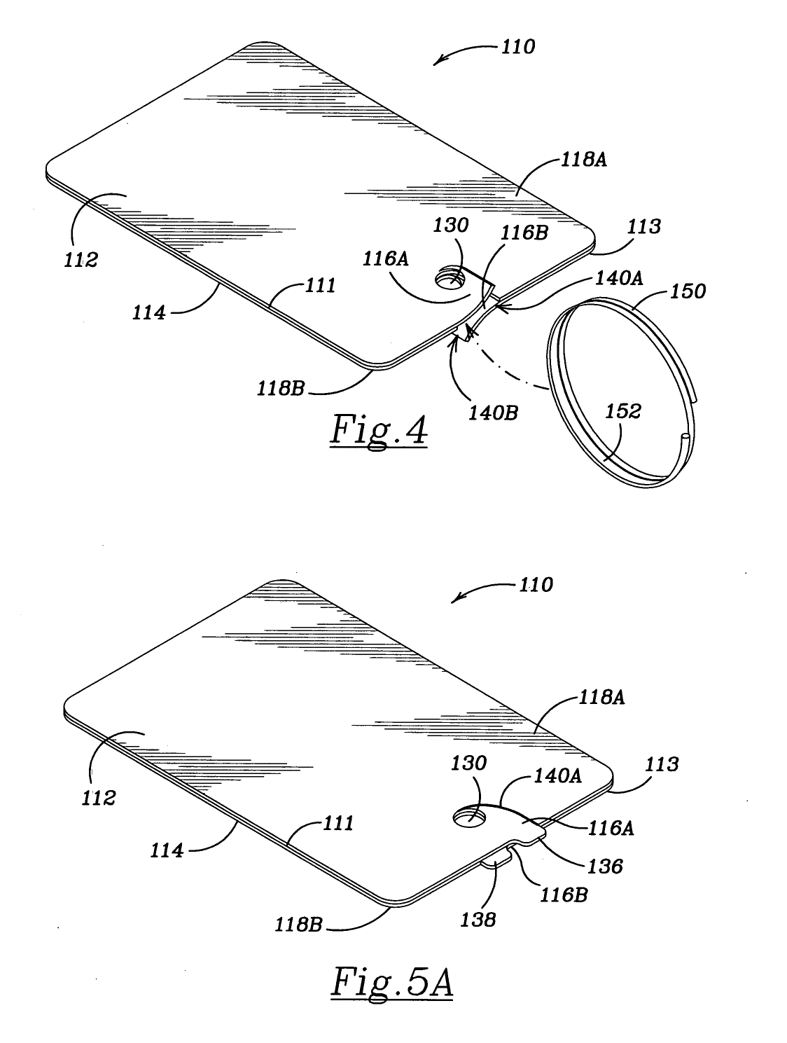

FIG. 4 is a perspective view of a second embodiment of the present invention showing a two-ply card and the card retaining member.

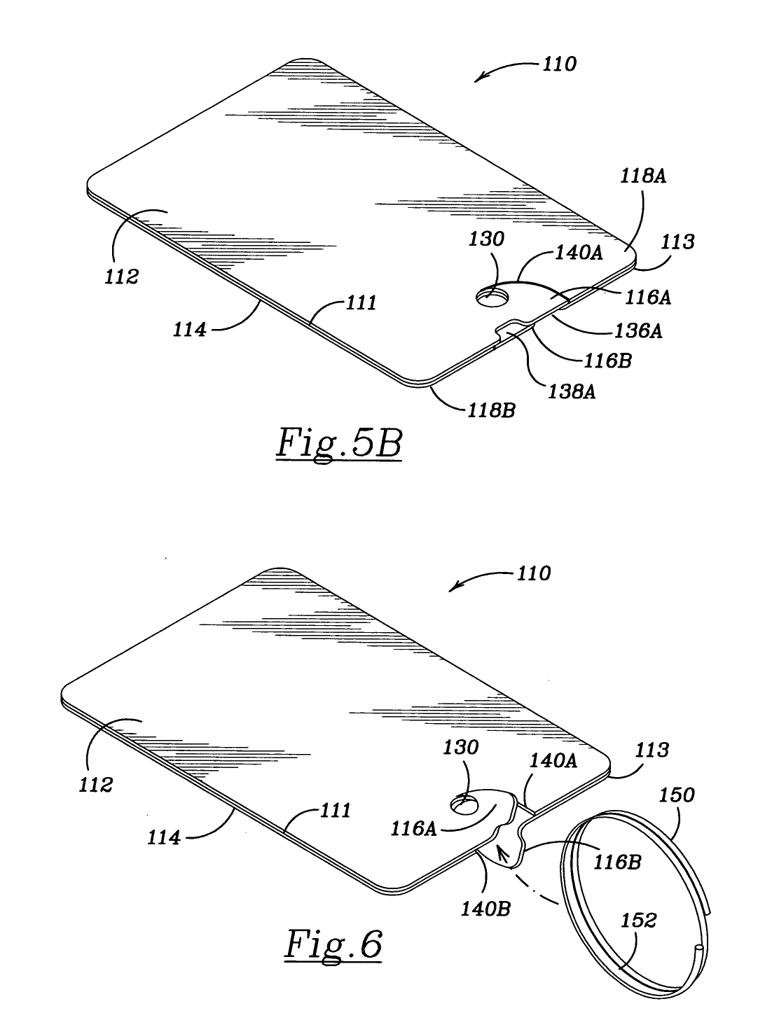

FIG. 5A is a perspective view of the second embodiment of the present invention showing a plurality of tab members associated with each of the opposing cooperating parts of the card retaining capture means.

FIG. 5B is a perspective view of the second embodiment of the present invention showing plurality of recesses formed along one edge of the card in each of the opposing cooperating parts of the card retaining capture means.

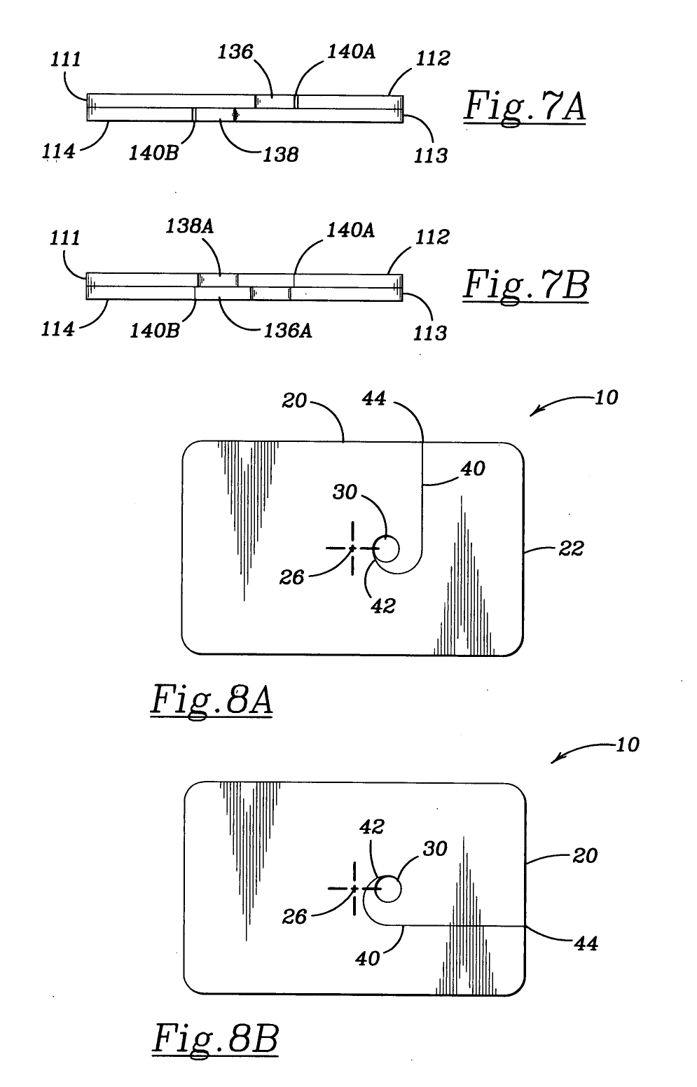

FIG. 6 is another view of the second embodiment of the present invention showing the manner in which the two-ply card is deformed to permit the insertion into and attachment of the card to the card retaining member.

FIG. 7A is a side elevational view of the card of the second embodiment of the present invention depicting a first geometry for the slot of the card retaining member capture means with the tab members of FIG. 5A.

FIG. 7B is a side elevational view of the card of the second embodiment of the present invention depicting an alternative geometry for the slot of the card retaining member capture means with the recesses in each of the opposing cooperating parts of FIG. 5B.

FIG. 8A is a top plan view of a first alternative placement of the card retaining capture means on the card of the present invention along one of the longer opposing sides of the card.

FIG. 8B is a top plan view of a second alternative placement of the card retaining capture means on the card of the present invention along one of the shorter opposing sides of the card.

FIG. 8C is a top plan view of a third alternative placement of the card retaining capture means on the card of the present invention in one of the corners of the card.

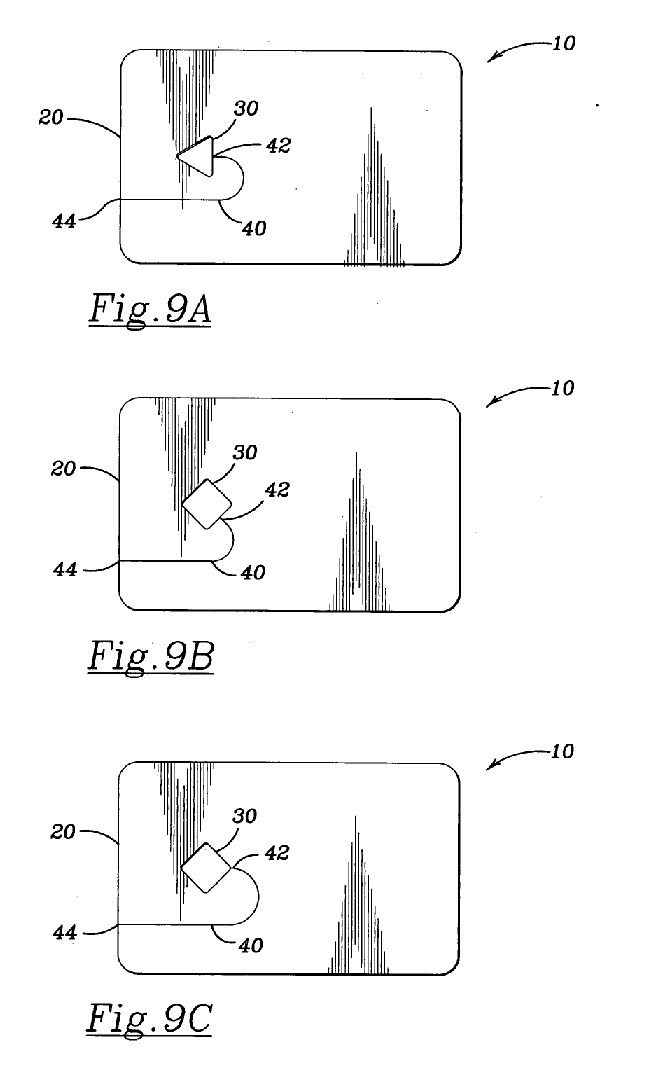

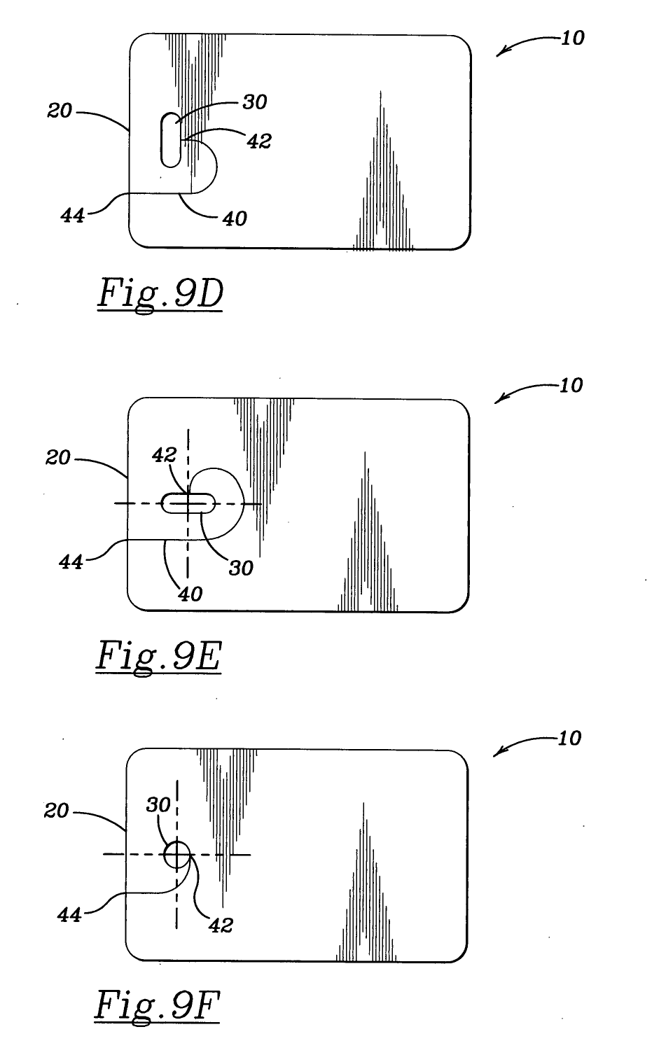

FIG. 9A is a top plan view of a first alternative geometrical shape for the aperture and position of the channel for passing the card retaining member into the aperture of the capture means of the card.

FIG. 9B is a top plan view of a second alternative geometrical shape for the aperture and position of the channel for passing the card retaining member into the aperture of the card retaining capture means of the card.

FIG. 9C is a top plan view of a third alternative geometrical shape for the aperture and position of the channel for passing the card retaining member into the aperture of the card retaining capture means of the card.

FIG. 9D is a top plan view of a fourth alternative geometrical shape for the aperture and position of the channel for passing the card retaining member into the aperture of the card retaining capture means of the card.

FIG. 9E is a top plan view of a fifth alternative geometrical shape for the aperture and position of the channel for passing the card retaining member into the aperture of the card retaining capture means of the card.

FIG. 9F is a top plan view of a sixth alternative geometrical shape for the aperture and position of the channel for passing the card retaining member into the aperture of the card retaining capture means of the card.

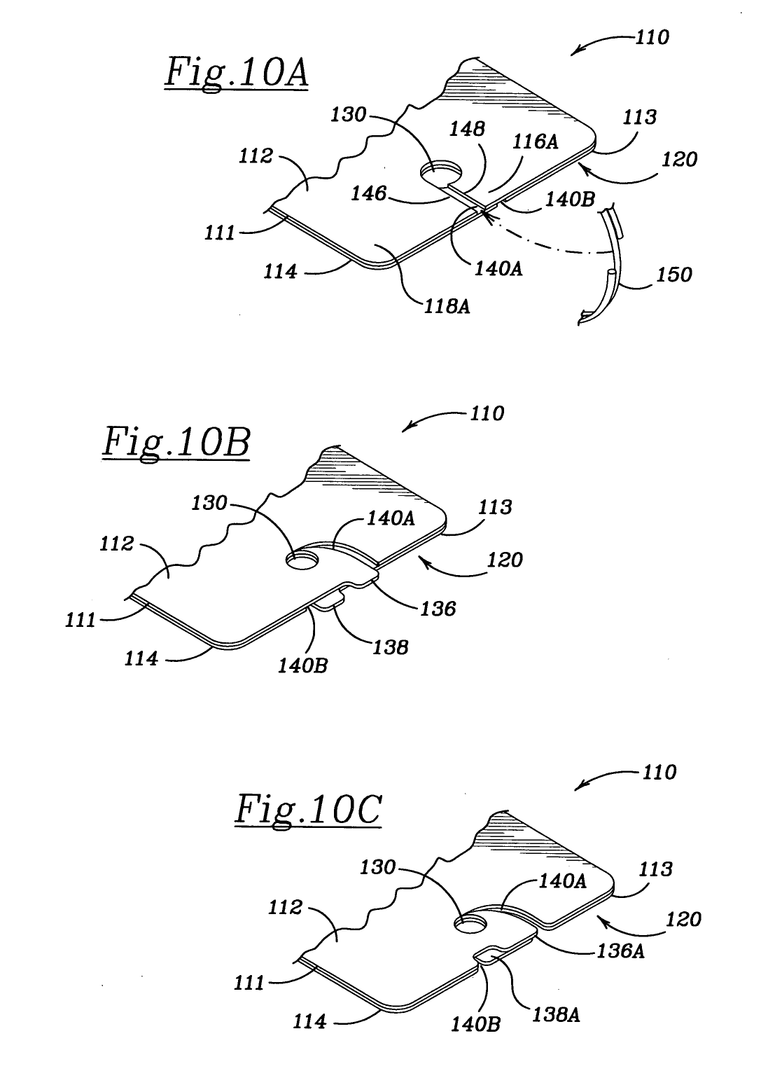

FIG. 10A is a perspective view of an alternative embodiment of the two-ply card of the present invention with a channel opening having a width dimension larger than the width of the card retaining member.

FIG. 10B is a perspective view of an alternative embodiment of the two-ply card of the present invention with a channel opening having a width dimension larger than the width of the card retaining member and showing a plurality of tab members associated with each of the opposing cooperating parts of the card retaining capture means.

FIG. 10C is a perspective view of an alternative embodiment of the two-ply card of the present invention with a channel opening having a width dimension larger than the width of the card retaining member and showing a plurality of recesses formed along one edge of the card in each of the opposing cooperating parts of the card retaining capture means.

### DETAILED DESCRIPTION OF THE INVENTION

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

Referring now to the drawings in detail, where like numerals refer to like parts or elements, there is shown an improved information-bearing card 10 and card retaining member 50 for removably securing the card to the card retaining member along with the primary elements of the present invention. The invention requires the card 10 to be configured with an aperture 30 and a slot 40, with the aperture 30 being located within the body of the card and the slot 40 running from the aperture 30 to an edge of the card. Further structural characteristics of the card 10 include it having a top surface 12, a bottom surface 14, and at least a first edge 20.

The slot 40 defines a first card portion 16 and a second card portion 18, with the first card portion 16 forming a first side 46 of the slot 40 and the second card portion 18 forming a second side 48 of the slot 40. Each card portion 16,18 is defined to include at least a portion of the first edge 20. While the card 10 may be of any practical shape, in the preferred embodiment it is rectilinear. In this embodiment, the first edge 20 is one of the shorter sides, and is substantially linear in configuration. Further, all of the elements described thus far are arranged in coplanar relationship when at rest.

The card 10 must be constructed of a substantially rigid, yet deformable material, such as a polyvinyl chloride polymer. It is substantially planar and has a substantially uniform thickness. An important characteristic of the card 10 is its ability to deform to some non-trivial degree from its initial shape by the application of a mechanical force and then to return to its original shape upon the cessation of that force. See FIGS. 2A, 4, and 6. The deformation may typically take the form of a bending of the material. Various acceptable materials will offer greater or lesser degrees of inherent deformability. Similarly, the specific structure of the card 10 will dictate the degree of deformability of various materials. For example, a card 10 having a greater uniform thickness may be less deformable than a card 10 having a relatively lesser uniform thickness, even though made from the same material. The card 10 may be of the one-ply or two ply versions shown in FIGS. 1 and 4, respectively, or even more plies for less deformability and greater retention by the card retaining member.

In addition to the characteristic of deformability, other important characteristics of the card 10 are its durability and reflex memory. That is, it must be able to withstand a sufficient amount of deformation to open the slot 40 on a repeated basis. Various acceptable materials will offer greater or lesser degrees of inherent durability. Similarly, the specific structure of the card 10 will dictate the degree of durability of various materials. The most desired materials from which the card 10 may be comprised offer a combination of deformability and durability.

In the preferred embodiment, the card 10 is comprised of polymers such as polyvinyl chloride, polyethylene, polypropylene, or PET (polyethylene terephthalate). Other embodiments may utilize relatively heavy grade paper, cardboard, metal alloys, composites, or certain relatively thin woods. As long as the characteristics of structural strength, resiliency, and flexural memory to sustain the deformability and durability of the invention are present, the invention is not limited to any specific material for the card 10.

Formed into the card 10 and completely through its entire thickness, from the top surface 12 through the bottom surface 14, is an aperture 30. The aperture 30 may be of any useful shape and dimension, as described more fully below in connection with FIGS. 9A-F, provided it is wholly contained within the card 10 such that the material comprising the card 10 completely surrounds the aperture 30, i.e., the aperture 30 may not be adjacent to the first edge 20 or any other border of the card 10. The circumference of the aperture 30, formed by the surrounding material comprising the card 10, is designated the aperture rim 32.

In the first embodiment, as shown in FIGS. 1-3, the aperture 30 is circular. In other embodiments the aperture 30 may be a regular polygon, an irregular polygon, an ovoid, an irregular curved shape, or a shape having a combination of straight and curved edges. See the description below concerning FIGS. 9A-F. A circular aperture 30 is preferred, however, because an aperture rim 32 lacking corners, protrusions, indentations, or other abrupt changes in the aperture circumference enables the card retaining member 50 to move freely within the aperture 30 and directs the card retaining member 50 to the position of preferred structural loading and prevents points of focused structural loading by intended or unintended force on the surrounding material comprising the card 10.

The slot 40 is formed into the card 10 from the top surface 12 to the bottom surface 14 extending through the entire thickness of the card 10. The slot 40 runs from the aperture 30 along a defined pathway to the first edge 20, creating a continuous communication between the aperture 30 and the first edge 20 of the card 10. The slot 40 defines a first card portion 16 and a second card portion 18, with the first card portion 16 forming a first side 46 of the slot 40 and the second card portion 18 forming a second side 48 of the slot 40. Each card portion 16, 18 is defined to include at least a portion of the first edge 20. The slot 40 may have a width, i.e., a separation between the first card portion 16 and the second card portion 18, such that is substantially uniform, and must be relatively smaller than the size of the aperture 30. See, for example, FIG. 3A. The width of the slot 40 may also be negligible, with the first card portion 16 being in contact with the second card portion 18 along some or all of the length of the slot 40. See FIGS. 3B and 3C. However, the first card portion 16 can only be attached to the second card portion 18 along a card segment between the aperture 30 and the first edge 20 as depicted by reference line 19 in FIG. 2A. Further, both the first and second card portions 16, 18 must be free to move relative to each other.

Where the card 10 has a relatively greater thickness at the slot 40, the unintentional opening of the slot 40 is decreased because the first and second sides 46, 48 of the slot 40 will come into contact with each other during deformation, thereby requiring a relatively greater force to open the slot 40. In FIGS. 3B, 3C and 3D the unintentionality of disengaging a card 10 from the card retaining member 50 can readily be seen. The sides 46, 48 of the slot 40 in FIGS. 3B and 3D are shaped such that the side 46 of the slot 40 along the first card portion 16 is substantially convex and the side 48 of the slot 40 along the second card portion 18 is substantially concave and configured to receive the convex side 46 of the slot 40. The convexity and concavity of the sides 46, 48 of the slot 40 may be angular or curved, or any combination thereof, and the convexity and concavity of the first and second sides 46, 48 of the slot 40 may be reversed from that as depicted.

While the two sides 46, 48 of the slot 40 may be configured to be separate from each other as explained above, they may also contact each other, with the first card portion 16 being in contact with the second card portion 18 along some or all of the length of the slot 40. This is shown in FIG. 3C where the slot 40 is formed by cutting at an angle so that the two edges 46, 48 of the slot 40 overlap one another. However, the first card portion 16 cannot be attached to the second card portion 18 and both the first and second card portions 16, 18 must be free to move relative to each other. The advantage of these geometries of the slot 40 is to require a relatively greater force to separate the two card portions 16, 18 when seeking to attach or detach the card 10 to or from the card retaining member 50, to force the two sides 46, 48 of the slot 40 past each other. This further guards against accidental detachment.

The invention contemplates using the card 10 and the card retaining member 50 in conjunction with each other. The card 10 is attached to the card retaining member 50 by applying a mechanical force to the card 10 in such a manner as to deform the card 10 along the slot 40 such that the first card portion 16 is disposed out of the plane of the card 10 and the second card portion 18 is disposed out of the plane of the card 10 in a direction opposite the disposition of the first card portion 16. This disposing of the first and/or second card portions 16, 18 may be seen as a bending of those portions in opposite directions relative to the plane of the card 10. As a result of the deformation of the first and second card portions 16, 18 from the plane of the card 10 by the application of the force, the slot 40 is widened to a sufficient degree to allow a portion of the card retaining member 50 to pass through the slot 40 between the first and second card portions 16, 18 along the extent of slot 40 and into the aperture 30. It is not necessary for the card retaining member 50 to pass between the first and second card portions 16, 18 without contacting either or both the first and second card portions 16, 18 and, in fact, it is anticipated that the card retaining member 50 will slide against one or both of the first and second card portions 16, 18 as it is inserted into and through the slot 40 and into the aperture 30. FIG. 2A shows the disposition of the first and second card portions 16, 18 and indicates the path the card retaining member 50 will follow when inserted into the slot 40. It should be noted that it may be possible to deform the first and second card portions 16, 18 in the same direction relative to the plane of the card 10, provided the card portions are deformed to a sufficient degree to permit passage through the slot 40 of the card retaining member 50. It may also be possible to deform only one of the first and second card portions 16,18 while leaving the other in its original position. Either of these alternatives will suffice provided the degree of deformation causes the slot 40 to be widened to a sufficient degree to allow a portion of the card retaining member 50 to pass through the slot 40 between the first and second card portions 16, 18 and into the aperture 30.

Once a portion of the card retaining member 50 is within the aperture 30, the force being applied to deform the card 10 is removed, causing the first card portion 16 and the second card portion 18 to return to their original positions, being substantially coplanar with the remainder of the card 10, and causing the slot 40 to return to its original width. The width of the slot 40 when the first and second card portions 16,18 are in their original positions must be smaller than the cross-section 52 of the card retaining member 50. FIG. 2B shows the card retaining member 50 successfully placed within the aperture 30 and the first and second card portions 16, 18 returned to their original positions.

Once the card 10 is attached to the card retaining member 50 as described above it is permitted to hang freely from the card retaining member 50. Because the first and second card portions 16, 18 return to their original positions and the slot 40 returns to its original width, the card retaining member 50 is retained securely within the aperture 30 and cannot pass easily out of the card 10. This method of attachment thus achieves the objective of the invention to easily yet securely attach a card 10 to a card retaining member 50. The rigidity of the material comprising the card 10, the width of the slot 40, the configuration of the first side of the slot 46 and the second side of the slot 48, and the short deformation radii prevent the card 10 from easily, unintentionally or accidentally detaching from the card retaining member 50.

An alternate embodiment of the single ply information bearing card 10 is the two-ply information bearing card 110 shown in FIGS. 4-7. The card 110 has a top ply 111 with a top surface 112. The card 110 also has a bottom ply 113 and a bottom surface 114. The top and bottom plies 111, 113 of the card 110 are adhered together except in the area of the slot 140. In this embodiment, the slot 140 is actually in two parts, an upper slot portion 140A and a lower slot portion 140B. The upper slot portion 140A separates the portions 116A and 118A of the upper ply 111 of the card 110 and the lower slot portion 140B separates the portions 116B and 118B of the bottom ply 113 of the card 110. The slot 140 connects the first edge 120 of the card 110 to the aperture 130 located a short distance from the edge 120 toward the center of the card 110. The card retaining member 150 is manipulated into the space adjacent to the slots 140A and 140B and between the two plies 111, 113 in order that the card retaining member 150 can exert a deflecting force against the two portions 116A and 116B to permit the card retaining member 150 to travel along the respective slots 140A, 140B and engage with the aperture 130. In this fashion the card retaining member 150 is inserted into the aperture 130 to hold the card 110. However, sometimes creating the small space necessary for the card retaining member 150 to force open the respective slots 140A, 140B is difficult. For this reason an alternate structure for the card 110 is described.

In FIGS. 5A and 5B there are depicted alternative means to assist the spreading apart of the respective portions 116A, 116B of the respective plies 111, 113 of the card 110 to permit the card retaining member 150 to be inserted therebetween and negotiate the slots 140A, 140B to the aperture 130. In FIG. 5A there are shown paired tabs 136, 138. The card retaining member 150 can more easily be inserted between the tabs 136, 138 in order to separate the card portions 116A, 116B and permit the card retaining member 150 to travel the length of the respective slots 140A, 140B to the aperture 130. In FIG. 5B there are shown two respective recesses 136A, 138A into which the card retaining member 150 may be inserted and twisted so as to separate the card portions 116A, 116B and permit the card retaining member 150 to travel the length of the respective slots 140A, 140B from the first edge 120 to the aperture 130. In this manner the card retaining member is securely lodged in the aperture 130 holding the card 110 within its confines.

The deflection of card portions 116A, 116B may be more readily discernible by reference to FIG. 6 in which these portions are deflected upward and downward, respectively, out of the plane of the card 110 to permit the insertion of the card retaining member 150 along the pathway created by slots 140A, 140B from the first edge 120 to the aperture 130. With reference to FIG. 7A one can readily discern the relationship of the tabs 136, 138 to their respective slots 140A, 140B, as well as the upper and lower card plies 111, 113 of the card 110. Also, in FIG. 7B, the relationship of the recesses 136A, 138A to their respective slots 140A, 140B, as well as the upper and lower card plies 111, 113 of the card 110 can be seen and understood. In these alternative structures of the card 10, 110 the width of the slot 40, or the slots 140A, 140B, is negligible and the amount of deformation of the card material is minimal.

In an alternative embodiment, as shown in FIGS. 10A-10C, the slot 140A may be wider, whereby the first card portion 116 and the second card portion 118 are not substantially in contact with each other along the length of the slot 140A. This wider slot 140A, increases the opening between the first and second sides 146, 148 of the slot 140A, thereby decreasing the amount of deflection or deformation of the card 110 needed to insert and attach the card retaining member 50. Therefore, a lesser amount of force is required to open the respective slots 140A, 140B when the slot spacing is greater than merely a cut in the card. This is also shown in FIGS. 10B and 10C in which the tabs 136, 138 and recesses 136A, 138A along the first edge 120 of card 110 are altered to accommodate the wider slots 140A, 140B.

In addition to the single ply card 10 and the two-ply card 110, the invention is also comprised of a card retaining member 50 or 150. The card retaining member 50, 150 may be of a closed ring type having a diameter E of at least the distance B from the first edge 20, 120 to the rim of the aperture 30, 130 and a thickness dimension of its cross-section 52 substantially larger than the width of the slot 40, 140. The cross-section 52 of the card retaining member 50, 150, as indicated as A′ in FIG. 1, must also be smaller than the diameter A of aperture 30, 130 such that a portion of the card retaining member 50, 150 fits within the aperture 30, 130. The card retaining member 50 may be constructed of a rigid material, such as metal or rigid plastic, for example, a key ring, or it may be constructed of a flexible material, such as twine or a flexible polymer, for example a lanyard. In the preferred embodiment, the card retaining member 50, 150 is a circular ring. The card retaining member 50, 150 may also be of any other practical shape having the characteristic of a closed loop, though a device which may be opened is also contemplated, as long as it has at least one closed loop state (for example, a key ring). The card retaining member 50, 150, as shown in FIG. 1, is a key ring. However, a key ring usually attaches to an object by separating the two loops of the key ring in order to slide the object in between the two rings for attachment. Separating the loops is not necessary with the present invention. In the present invention the card 10, 110 is deformable, thereby enabling any type of closed loop to attach, whether it is a double loop like the key ring or a single loop.

In an alternative embodiment, the card retaining member 50, 150 may be of a finite linear strand with at least two distantly displaced stops positioned on the linear strand, each stop larger than the diameter of the card aperture 30, 130, such that the card 10, 110 may be attached to the card retaining member 50, 150 between each of the stops, with the linear strand retaining the card 10, 110 between the stops preventing the card from slipping off the card retaining member 50, 150. The card retaining member 50, 150 may be a “nonfinite” linear strand, such as electrical wire, cable, rope, or the like, where in its operative state the linear strand has no apparent end. It is also contemplated that the card retaining member 50, 150 may be a solid rod, a pipe, or other elongated rigid structure, either with stops or without stops if of a “nonfinite” application.

The card retaining member 50 may be made of any material having the characteristics of substantial durability for continuous use with the card 10, 110. In the preferred embodiment the card retaining member 50, 150 is made from a rigid metal. Other acceptable materials include polymers, wood, glass, composites, fiber, animal hide, and the like. As long as the characteristic of substantial durability is present, the invention is not limited to any specific material for the card retaining member 50, 150.

More than one card 10, 110 may be attached to a single card retaining member 50, 150. The card retaining member 50, 150 may be attached to a belt loop, a wall peg, or any other point of attachment to hold the one or more attached cards 10, 110 in their desired location, or the card retaining member 50, 150 and the one or more attached cards 10, 110 may be placed in a container or upon a surface without further securing the card retaining member 50, 150 to that container or surface, for example, the card retaining member 50, 150 with one or more attached cards 10, 110 may be placed in a pocket or purse.

In the following process for attaching and detaching a card or cards from a card retaining member, the reference to one of the identifying numerals will suffice to include both, or all, of the related identifying numerals for such element of the invention. A card 10 that has been attached to the card retaining member 50, as described above, may be detached from the card retaining member 50 by applying a mechanical force to the card 10 to deform the card 10 along the slot 40 such that the first and/or second card portions 16, 18 are displaced or deflected as described above. As a result of the deformation of the first and/or second card portions 16, 18 from the plane of the card 10 by the application of the force, the slot 40 is widened to a sufficient degree to allow a portion of the card retaining member 50 to pass out of the aperture 30 and through the slot 40 between the first and second card portions 16, 18. It is not necessary for the card retaining member 50 to pass between the first and second card portions 16, 18 without contacting either or both the first and second card portions 16, 18, and in fact it is anticipated that the card retaining member 50 will slide against one or both of the first and second card portions 16, 18 as it is removed from the aperture 30 and out through the slot 40. When the card retaining member 50 is fully removed from the aperture 30 and out through the slot 40, the force being applied to the card 10 is ended, causing the first card portion 16 and the second card portion 18 to return to their original coplanar positions and causing the slot 40 to return to its original width.

The above-described mechanical force to attach the card 10 to the card retaining member 50 may be a combined opposition and relative twisting of the card retaining member 50 against the card 10. That is, the card retaining member 50 is placed against the first edge 20 relatively close to the slot 40 and pushed into the slot 40 in the general direction of the aperture 30, while the card 10 is pushed into and twisted against the card retaining member 50. The twisting motion readily causes the first and second card portions 16, 18 to separate as described above. To detach the card 10 from the card retaining member 50, the card 10 and the card retaining member 50 may be pulled in opposite directions, with the card retaining member 50 being twisted relative to the card 10; this twisting forces the deflection of the first and second card portions 16, 18 in substantially opposite directions and the card retaining member 50 may be removed. These forces must be sufficient to overcome the inherent rigidity of the material comprising the card 10 and the mechanical force for displacement of the sides 46, 48 of the slot 40 past each other. In the preferred embodiment this force should be substantially greater than the forces generated by the weight of the card 10, or by normal handling, use and storage of the card 10. Other applications of force may be applied to effect the attachment and detachment of the card 10 as desired without deviating from the spirit of the invention.

The slot 40 of card 10 may be further described as having an aperture end 42 and an edge end 44. The aperture end 42 of the slot 40 is that end of the slot 40 in direct communication with the aperture 30. The edge end 44 of the slot 40 is that end of the slot 40 in direct communication with the first edge 20 of the card 10. In the preferred embodiment the aperture end 42 of the slot 40 is aligned along a tangent of the circumference of the aperture 30, and the edge end 44 of the slot 40 is aligned in substantial perpendicularity to the first edge 20 of the card, as shown on FIG. 2B. Further, in the preferred embodiment, the slot 40 extends inward from its edge end 44 at the first edge 20, at least a distance B, and then travels along a substantially curved path toward the aperture end 42 along the inward facing circumference of the aperture 30. Other configurations and orientations of the slot 40 are also contemplated by the invention as described below.

Orientation of the slot 40 when the aperture 30 is non-circular is such that the aperture end 42 of the slot 40 is not located at a point of focused loading or where the card retaining member can be lodged in a fixed position during normal operative use. See FIGS. 9A-F. In FIG. 9A the aperture 30 is shaped as a triangle with the aperture end 42 of the slot 40 along the base of the triangle shape, where the base is parallel to the first edge 20 and is farthest in distance from that edge. FIGS. 9B and 9C show the aperture 30 in the shape of a square with the aperture end 42 of slot 40 attached along a side of the square aperture in FIG. 9B and at a corner of the square aperture in FIG. 9C. In FIG. 9D the aperture 30 is shaped as an elongated oval having the longer sides parallel to the first edge 20 of the card 10. The aperture end 42 of the slot 40 enters the aperture 30 approximately midway along the elongated side of the oval facing away from the first edge 20 as depicted in FIG. 9D. In FIG. 9E the aperture 30 in the shape of elongated oval is rotated 90° so that the centerline of the elongated oval is perpendicular to the first edge 20 of the card 10. In this case the aperture end 42 of the slot 40 is positioned along the reverse elongated side of the aperture 30 such that the slot 40 extends around the distal radial end of the oval and connects as shown in FIG. 9E. Finally, in FIG. 9F, the original round shape of the aperture 30 is depicted with perpendicular grid lines overlaid over its center point showing the aperture end 42 of the slot 40 connecting to the aperture 30 at the tangent point most distant from the first edge 20 of the card 10. The attachment point of the aperture end 42 occurs at the point on the rim 32 of aperture 30 that is aligned with a line perpendicular to the first edge 20 and extending through the center of the aperture 30. It is this configuration that is explained above for maximizing the secure containment of the card retaining member 50 within the card aperture 30.

The purpose of aligning the aperture end 42 of the slot 40 along a tangent of a curved circumference aperture 30 is to make the attachment of the card 10 to the card retaining member 50 more secure. When the aperture end 42 of the slot 40 is tangential to the aperture 30, the card retaining member 50, when it is situated within the aperture 30, cannot exert a force against the aperture rim 32 at the aperture end 42 that is collinear with the slot 40 so that the slot opens. That is, any force exerted by the card retaining member 50 against the aperture rim 32 at the aperture end 42 of the slot 40 will be at a 90° angle to the tangential direction of the aperture end 42 of the slot 40. This orientation of the slot 40 relative to the aperture 30 improves the security of the attachment of the card 10 to the card retaining member 50 because it requires a change in direction of force to cause the card retaining member 50 to enter the slot 40, i.e., the twisting motion described above. It also permits the card retaining member 50 to naturally slide past the aperture end 42 of the slot 40 when the card 10 is hanging freely from the card retaining member 50.

While the aperture end 42 of the slot 40 may be oriented other than tangentially to the aperture 30, the more perpendicular the slot 40 is to the aperture 30 the less resistance is provided to an unintended force opening the slot 40. The purpose of having a partial curvilinear pathway for the slot 40 from the aperture end 42 to the edge end 44 magnifies this security feature, requiring a constantly changing direction of force to pass the card retaining member 50 along the slot 40. Thus, an accidental or unintended application of force to a card 10 attached to the card retaining member 50 is unlikely to cause the card to detach, because an accidental or unintended application of force is unlikely to act in the multi-directional manner required by the curved shape of the slot 40.

In the most preferred embodiment, the aperture end 42 of the slot 40 is aligned along a tangent to the aperture 30 at a point along the aperture rim 32 farthest from the first edge 20. This yields the best security when the card 10 is attached to the card retaining member 50 and is allowed to hang freely. The weight of the card 10 will be supported along the aperture rim 32 closest to the first edge 20, and thus farthest from the aperture end 42 of the slot 40. This minimizes the potential for an accidental force to cause the card retaining member 50 to align perfectly with the aperture end 42 of the slot 40. This also ensures that the greatest possible amount of card material will be present between the card retaining member 50 and the slot 40 when the attached card 10 is freely hanging, thereby minimizing the risk of the card 10 itself breaking if an accidental force is applied to it. Additionally, when the card 10 is to be detached and a force is applied, as described above, the card retaining member 50 is forced against the portion of the aperture 30 backed by the greatest amount of card material, further minimizing the risk of breakage.

The preferred circular shape of the aperture 30 also makes the attachment of the card 10 to the card retaining member 50 more secure. Because the entire aperture rim 32 is curved, there is no natural point for the card retaining member 50 to lodge against and thus create a point of focused loading onto which an unintentional or accidental force can act. In the absence of points of focused loading on the aperture rim 32, the slot 40 is less likely to unintentionally or accidentally open, and the card 10 is less likely to break.

In one embodiment, the edge end 44 of the slot 40 intersects the first edge 20 along a line perpendicular to the first edge 20 such that the perpendicular line does not intersect the aperture 30, as shown in FIG. 1. With the edge end 44 of the slot 40 offset from any line perpendicular to the first edge 20 that may intersect the circumference of the aperture 30, the card retaining member 50 cannot easily be pulled directly out of the aperture 30 through the slot 40 to the first edge 20. The card retaining member 50 must be intentionally manipulated to the aperture end 42 of the slot 40, rather than being unintentionally or accidentally pulled through the slot 40 to the edge end 44 of the slot 40. By keeping the slot 40 out of direct alignment with the aperture 30 relative to the first edge 20 of the card 10, a greater amount of card material between the aperture 30 and the first edge 20 of the card 10 structurally resists an accidental or unintentional force against the aperture rim 32, thereby preventing deformation of the card 10 and opening the slot 40. This further makes the attachment of the card 10 to the card retaining member 50 more secure.

In the preferred embodiment of the invention the aperture 30 should be located closer to one end of the card 10, but should not be too close to the first edge 20 of the card 10 to avoid compromising the structure of the card 10 to resist unintentional or accidental force against the aperture rim 32, and to avoid compromising the durability of the card 10. In this embodiment, shown in FIG. 1, the circular aperture 30 is located between the card midpoint 28 and the first edge 20, and the straight line distance B measured perpendicularly from the first edge 20 of the card 10 to the point of the aperture rim 32 nearest the first edge 20 is greater than the diameter A of the aperture 30.

In the most preferred embodiment, where the card 10 is substantially rectangular in shape, the first edge 20 of the card is along a shorter side of the card 10, and the card 10 has a second edge 22, a third edge 24, and a fourth edge 26. The second edge 22 is adjacent to the first edge 20 along a longer side of the card 10, the third edge 24 is adjacent to the first edge 20 along the other longer side of the card 10 and opposite the second edge 22 of the card, and the fourth edge 26 is opposite the first edge 20. In the depiction of the card 10 in FIG. 1, the straight line distance C measured perpendicularly from the second edge 22 to the point of the aperture rim 32 nearest the second edge 22 is greater than the diameter A of the aperture 30, and the straight line distance D measured perpendicularly from the third edge 24 to the point of the aperture rim 32 nearest the third edge 24 is greater than the diameter A of the aperture 30. The purpose for the aperture 30 to be so situated is to provide a point of attachment near an end of the card 10 for ease of use while still providing sufficient card material surrounding the aperture 30 to lessen the likelihood of the card 10 breaking or unintentionally deforming during use. This further makes the attachment of the card 10 to the card retaining member 50 more secure.

In the most preferred embodiment, where the card retaining member 50 is a circular ring, the internal diameter E of the ring is greater than the greatest straight line distance B from the point of intersection of the slot 40 with the first edge 20 to any point of the aperture rim 32. This dimensional relationship is also shown in FIG. 1. By having the card retaining member 50 so dimensioned, it is not possible for card retaining member 50 to be accidentally aligned with the edge end 44 of the slot 40 while the card 10 is attached thereto, necessitating the deformation of the card 10 to initiate detachment. This further makes the attachment of the card 10 to the card retaining member 50 more secure.

With reference to FIG. 8A, the card 10 is substantially rectangular in shape, but the first edge 20 is now along one of the longer sides of the card 10. The card 10 further has a second edge 22. The second edge 22 is adjacent to the first edge 20 along a shorter side of the card 10. In this embodiment the aperture 30 is located between a midpoint of the card 26 and the second edge 22. However, the aperture 30 is closer to the midpoint 26 of the card 10 in order to avoid any interference with a magnetic stripe, embossed alphanumeric characters or holographic image carrying information that may be positioned across a short side of the card 10. Alternatively, in FIG. 8B, the aperture 30 is positioned much closer to the midpoint 26 of the card 10 than in FIG. 1, but with sufficient clearance between the aperture 30 and slot 40 and longer side 24 to, again, avoid any interference with a magnetic stripe, embossed alphanumeric characters or holographic image carrying information, that may be positioned across a long side of the card 10. The aperture end 42 of the slot 40 is aligned along a tangent to the aperture 30 and the edge end 44 of the slot 40 is aligned substantially perpendicular to the first edge 20. The slot 40 also may also have a curvilinear portion extending away from the aperture end 42 to the edge end 44.

Those skilled in the art will perceive improvements, changes and modifications in the invention. Such improvements, changes and modifications within the skill of the art are intended to be covered by the claims set forth herein, and that all matter contained in the accompanying specification shall be interpreted as illustrative only and not in a limiting sense. The present invention may also be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A card retaining apparatus comprising a card, said card being constructed of a substantially rigid yet deformable material and being substantially planar with a substantially uniform thickness, having a top surface, a bottom surface, a first edge, an aperture, a slot, and a card retaining member;
said aperture located within the body of the card and formed through the entire thickness of the card, from the top surface to the bottom surface and having a rim along its external periphery;
said slot located adjacent to and extending away from said first edge and formed through the entire thickness of the card, from the top surface to the bottom surface, forming a passage between the aperture and the first edge of the card and having a width less than the most distant points for measuring the opening of the aperture, said passage being formed by flexing the opposing sides of the slot away from each other deforming each of them out of their coplanar relationship; and,
said card retaining member having a cross-sectional dimension smaller than the opening of the aperture, such that a portion of the card retaining member may fit within the aperture, and larger than the width of the slot, such that the card retaining member may be used to deform the opposing sides of the slot away from their coplanar relationship, pass through the passage formed by the slot, and be retained within the aperture.

2. The apparatus of claim 1, wherein the card is substantially rectangular in shape, with the first edge being along a shorter side of the card and the aperture being located between a midpoint of the card and the first edge.

3. The apparatus of claim 1, wherein the card is substantially rectangular in shape, with the first edge being along a longer side of the card and the aperture being located between a midpoint of the card and the first edge.

4. The apparatus of claim 1, wherein the card retaining member is constructed of a rigid material.

5. The apparatus of claim 1, wherein the card retaining member is constructed of a flexible material.

6. The apparatus of claim 1, wherein the card retaining member is a closed ring.

7. The apparatus of claim 1, wherein the card retaining member is linear and comprises at least two stops, said stops being distantly positioned on the card retaining member and each stop being larger than the diameter of the card aperture.

8. The apparatus of claim 1, wherein the slot further comprises a first side and a second side, said first side of the slot formed along a first card portion and said second side of the slot formed along a second card portion, with the first side of the slot being substantially convex and the second side of the slot being substantially concave so that the first and second sides of the slot substantially mate with one with the other.

9. The apparatus of claim 1, wherein the slot further comprises a first side and a second side, said first side of the slot formed along a first card portion and said second side of the slot formed along a second card portion, with the first side of the slot being angled upward away from the bottom surface of the card and the second side of the slot being angled downward away from the top surface of said card so that the first and second sides of the slot substantially mate with one with the other.

10. The apparatus of claim 1, wherein the aperture may be configured in any of the geometric configurations selected from the group consisting of substantially circular, oval, elongated oval, square, rectangular, diamond shaped, and triangular.

11. The apparatus of claim 1, wherein said ring has an internal diameter that is greater than the greatest straight line distance from the point of intersection of the slot with the first edge to any point on the rim of the aperture.

12. The apparatus of claim 11, wherein the shortest straight line distance measured perpendicularly from the first edge to a point on the aperture rim nearest the first edge is greater than the diameter of the aperture.

13. The apparatus of claim 1, wherein the slot further comprises an aperture end and a card edge end, said aperture end of the slot being aligned along a tangent point to the aperture rim, and the card edge end of the slot being aligned perpendicularly to the first edge.

14. The apparatus of claim 1, wherein the slot further comprises an aperture end and a card edge end, said aperture end of the slot being aligned with the aperture rim, and the card edge end of the slot intersecting the first edge along a perpendicular to the first edge such that said perpendicular does not intersect the aperture.

15. The apparatus of claim 1, wherein the slot further comprises an aperture end and a card edge end, said aperture end of the slot being aligned along a tangent point to the aperture rim, said card edge end being aligned perpendicular to the first edge, and the slot being partly curved outward from the aperture end to the card edge end.

16. The apparatus of claim 15, wherein the aperture end of the slot is aligned along the tangent to the aperture at a point along the aperture rim farthest from the first edge.

17. The apparatus of claim 16, wherein the aperture end of the slot is aligned along a tangent to the aperture at a point along the aperture rim that is parallel to a line perpendicular to the first side but on the opposite side of the aperture as the slot.

18. The apparatus of claim 1, wherein the card is further comprised of at least two plies of material, a first ply of material atop a second ply of material, and said slot further comprises a first slot portion in the first ply being spaced apart and opposing a second slot portion in the second ply so that there are formed cooperating first and second slot portions in each of the first and second plies that are deformable in opposite directions to permit the retaining member to pass therebetween.

19. The apparatus of claim 18, wherein the first and second slot portions in each of the first and second plies have a first side and a second side with the first side of the first slot portion formed along a first card portion and the second side of the first slot portion formed along a second card portion, and the first side of the second slot portion formed along the second card portion and the second side of the second slot portion formed along the first card portion such that the first slot portion and the second slot portion form a passage therebetween when flexed outward by the insertion of the retaining member between them.

20. The apparatus of claim 18, wherein each of the first and second slot portions further comprise a means for flexing the respective slot portions away from each other.
